(19) United States
(12) Patent Application Publication
(10) Pub. No.: US 2003/0005065 A1
(43) Pub. Date: Jan. 2, 2003

(54) Emulated real E-mail system and method

(76) Inventors: Kuang-Shin Lin, Taipei (TW); Sayling Wen, Taipei (TW); Zhen Ma, Tianjin (CN)

Correspondence Address: BIRCH STEWART KOLASCH & BIRCH, PO BOX 747, FALLS CHURCH, VA, 22040-0747, US

(21) Appl. No.: 10/183,558

(22) Filed: Jun. 28, 2002

(30) Foreign Application Priority Data
Jun. 29, 2001 (TW) 90115898

(51) Int. Cl. G06F 15/16; G09G 5/00

(52) U.S. Cl. 709/206; 345/744

(57) ABSTRACT

An Emlated real E-mail system and method is disclosed in the invention. It is a utility under an OS that can operate with different OS's. The user can complete a desired task with a single action using the UOI provided by the invention. The invention can perform E-mail receiving and sending, mail folder organization, and E-mail account setting, creating a full electronic mail system. The invention includes at least the steps of: receiving a request signal from a user, analyzing the request signal using a functional module management mechanism, calling a corresponding functional module according to the request signal, and completing a desired process through the corresponding module.

### BACKGROUND OF THE INVENTION

1. Field of the Invention

The invention relates to an OS (Operating System) and, in particular, to an Emulated real E-mail (Electronic mail) system and method that can operate with different OS's.

2. Related Art

With the increase in computer popularity, people often need to use computers to solve problems either at work or at home. Besides solving problems, people have the demand of using computers to communicate with others. But there are some causes that still produce the difficulty for people to use computer to communicate with others. One can see the causes in the following points:

1. Existing personal computer OS's (Operating Systems), such as MS Windows, Linux, and so on, are complicated despite of their powerful functions and designs. Moreover, the user operation designs are not intuitive and simple enough. This situation scares people without any computer background because of the obstacles they meet while using these systems.

2. Users are often unable to intuitively use currently available E-mail systems. In particular, users have trouble setting up accounts. What is more troublesome are the attached files in E-mail messages. If the attached files are directly stored in a temporary directory of the OS by default, such temporary files will eventually lower the efficiency of the system if the user does not take care of them.

Because of the above, it is thus highly desirable to provide a simple and convenient OS with an Emlated real E-mail system and method to solve these problems.

### SUMMARY OF THE INVENTION

In view of the foregoing, the invention provides a simulated E-mail system and method. The system is based on a one-touch OS, the main objective of which is to use a finite number of keys as hot keys to achieve the operation of various functions. In this OS, each function is initiated by a single key, thus implementing convenience and intuition of operation and increasing users' interest in using computers. Using the functions of receiving E-mail, sending E-mail, managing mail folders, and account settings, the user can easily achieve the above-mentioned objective and use the simulated E-mail system to manage all E-mail messages.

The one-touch OS is mainly designed for people without any computer background or experience. It provides a simple and intuitive UOI (User Operating Interface). It is an OS that can operate with the existing system. Therefore, there will be two OS's on a computer hardware platform. Such a computer has the so-called dual-OS.

Based upon the above-mentioned advantages, any computer in which the disclosed E-mail system is installed enables the user to conveniently manage his or her E-mail messages. Thus, the invention can facilitate computer sales and use.

The disclosed method includes at least the steps of: receiving a request signal from a user, analyzing the request signal using a functional module management mechanism, calling a corresponding functional module according to the request signal, and completing a desired process by the corresponding module.

### BRIEF DESCRIPTION OF THE DRAWINGS

The invention will become more fully understood from the detailed description given hereinbelow. However, the following description is for purposes of illustration only, and thus is not limitative of the invention, wherein:

FIG. 1 shows the structure of the disclosed Emulated real E-mail system;

FIG. 2-a shows the event flowchart of the disclosed Emulated real E-mail method;

FIG. 2-b shows the flowchart of a subprocess in FIG. 2-a;

FIG. 2-c shows the flowchart of another subprocess in FIG. 2-a;

FIG. 2-d shows the flowchart of yet another subprocess in FIG. 2-a;

FIG. 3 is a schematic view of browsing E-mail messages according to the disclosed system and method;

FIG. 4 is a schematic view of displaying attachments according to the disclosed system and method;

FIG. 5 is a schematic view of Internet setting according to the disclosed system and method; and

FIG. 6 is a schematic view of E-mail account setting according to the disclosed system and method.

### DETAILED DESCRIPTION OF THE INVENTION

The invention proposes an Emlated real E-mail system and method. In contrast to currently complicated OS's (Operating System), the invention provides a convenient and intuitive UOI (User Operating Interface). The user can complete any desired effect by hitting a single key (hot key) on the keyboard. By linking to a network, the user can receive mail, send mail, organize mail folders and manage his or her account settings using a one-touch OS.

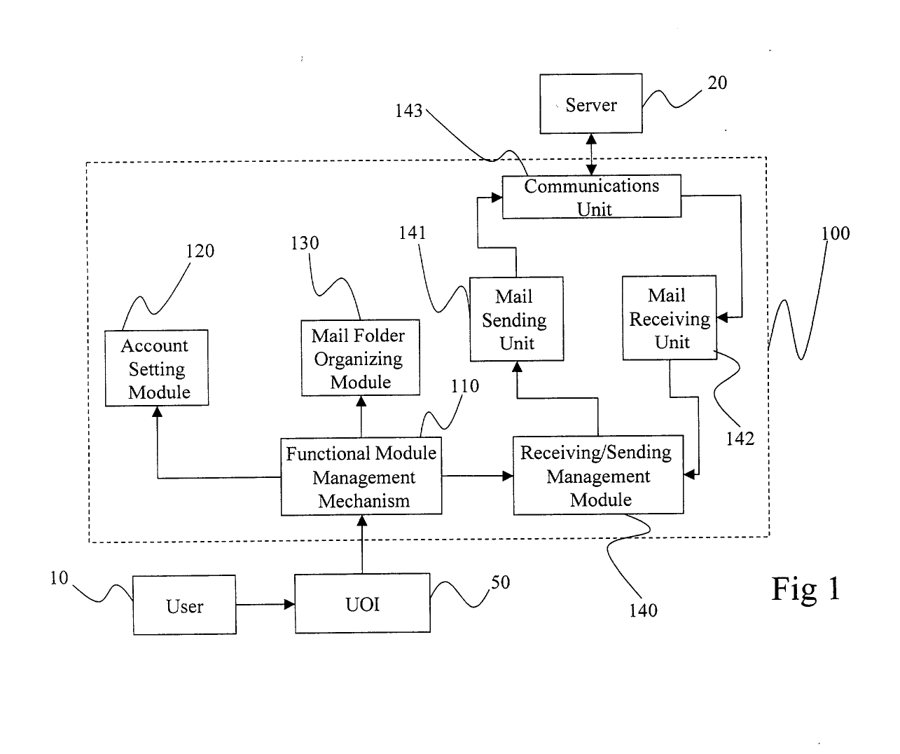

A preferred embodiment of the disclosed Emulated real E-mail system is shown in FIG. 1. The invention provides a functional module management mechanism 110 to process the management of E-mail in the one-touch OS 100. By using the UOI 50, the user 10 can efficiently interact with the computer. When the user 10 enters the functional module management mechanism 110 provided in the one-touch OS 100 through the UOI 50, all E-mail procedures in the system are initiated. The functional module management mechanism 110 includes (1) an account setting module 120, (2) a mail folder organizing module 130, and (3) a receiving/sending management module 140.

1) The account setting module 120 provides at least one field for storing various E-mail account parameters of the user 10 and generates a complete account for receiving/sending E-mail. The account parameters include at least a user name, an E-mail address, a POP3 (Post Office Protocol), an SMTP (Simple Mail Transfer Protocol), a login name, and a password.

2) The mail folder organizing module 130 classifies E-mail according to the file type of the attached document and automatically files the messages into folders. This module first detects the type of attached files. Once the types (e.g. bmp, gif, jpg, mp3, wav, mid, html, etc) are determined, the messages are then automatically filed into mail folders.

3) The receiving/sending management module 140 controls the processes of receiving/sending E-mail messages through a complete account. This module further contains (a) a mail sending unit 141, (b) a mail receiving unit 142, and (c) a communications unit 143.

a) The mail sending unit 141 accesses an E-mail message stored inside an internal storage medium 160 of a computer executable hardware platform and sends it out according to the complete account.

b) The mail receiving unit 142 retrieves E-mail messages belonging to the complete account stored in the server 20.

c) The communications unit 143 connects the receiving/sending management module 140 and the server 20 for transmitting E-mail.

The one-touch OS 100 refers to an OS that enables a user 10 to complete a function provided in the work group displayed in the UOI 50 in one action. The work group is comprised of at least one function item. The one-touch OS 100 can operate with other different OS's or alone. The user chooses to switch between the different OS's. The UOI 50 can generate at least one such work group.

The one-touch OS 100 can run on any computer executable hardware platform, such as a PC (Personal Computer), an NB (Notebook), or a PDA (Personal Digital Assistant). Any person skilled in the art can make various modifications to implement the disclosed Emulated real E-mail system in any electronic device that can communicate with the network.

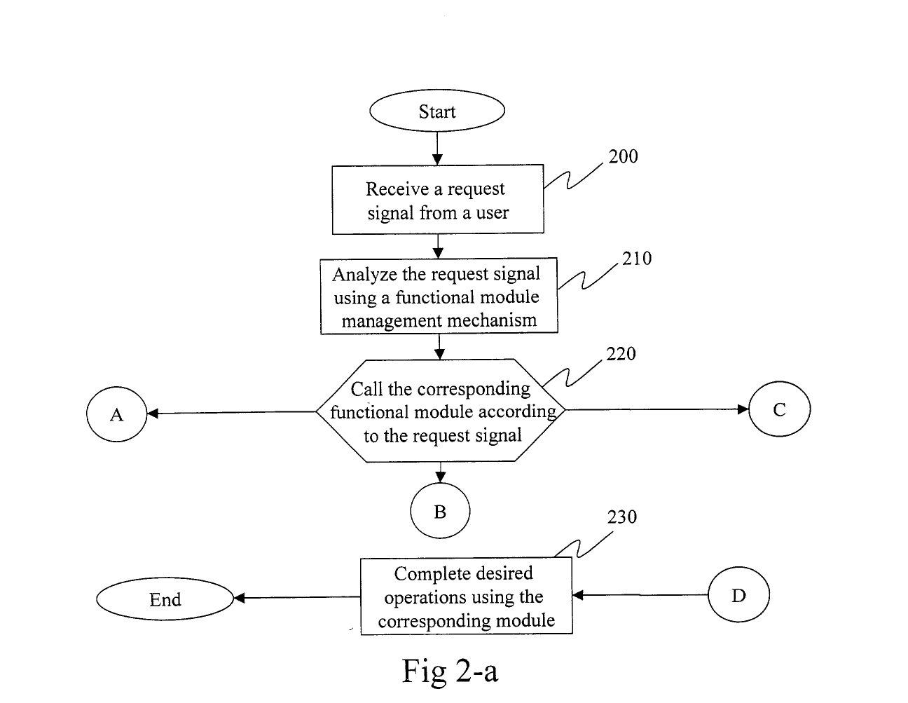

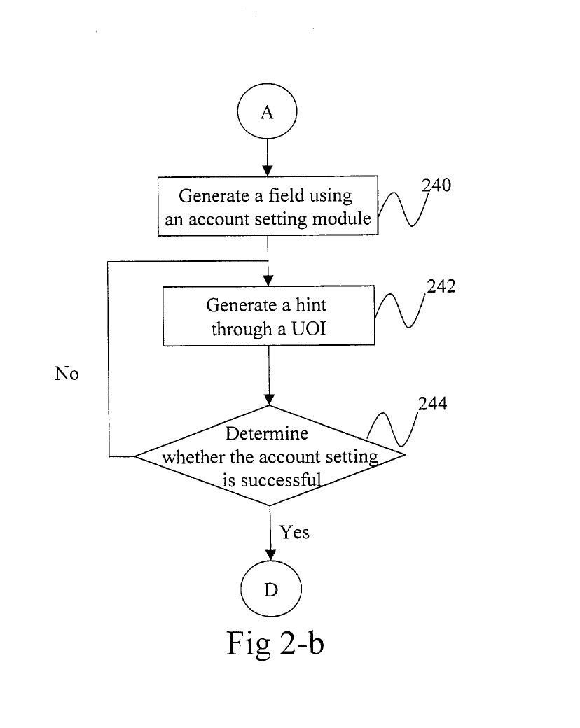

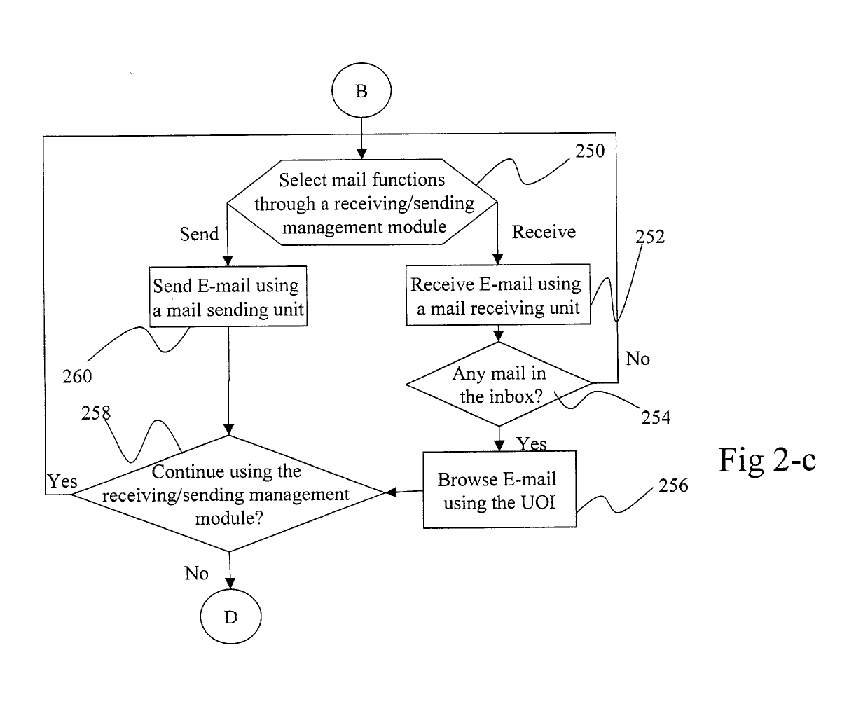

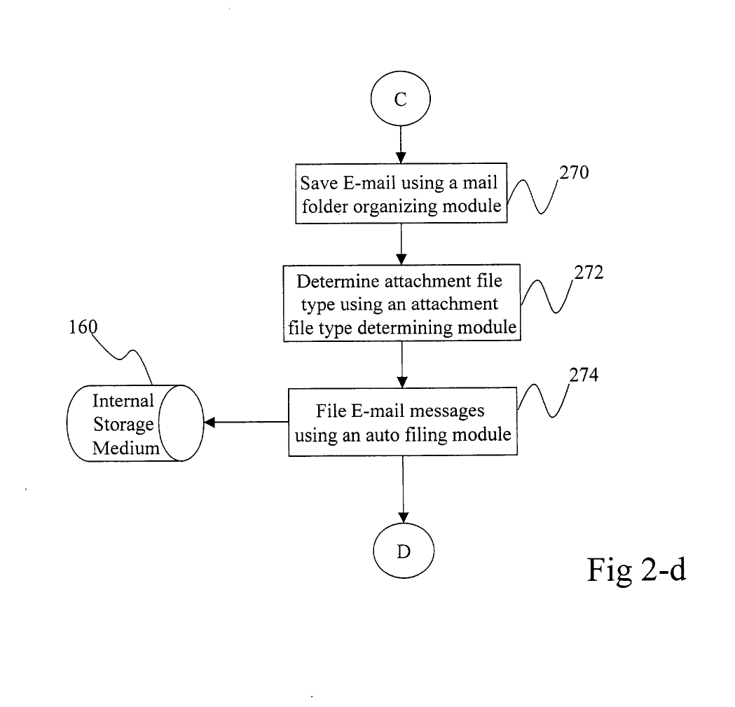

FIG. 2-a shows the event flowchart of the disclosed Emulated real E-mail method. First, the one-touch OS 100 is initiated to receive a request signal from a user 10 (step 200). Afterwards, a functional module management mechanism 110 analyzes the request signal (step 210). If it is a valid signal, then the corresponding functional module is called according to the request signal (step 220). This functional module is included in the functional module management mechanism 110. With different functional modules, the procedures continue to steps A, B and C, respectively.

With reference to FIG. 2-b, after step A an account setting module 120 generates a field (step 240). The user 10 can perform account settings within the field. A UOI 50 then generates a hint (step 242). The account setting module 120 guides the user 10 to complete the procedure. Step 244 determines whether the account setting is successful. If not, the procedure goes back to step 242. If it is successful, then step D follows. With reference to FIG. 2-a, the corresponding module then completes the required tasks (step 230) and the process finishes.

With reference to FIG. 2-c, after step B a receiving/sending management module 140 selects mail functions (step 250). If the user wants to receive messages, then a mail receiving unit receives the E-mail (step 252). Step 254 determines whether any E-mail messages exist in the inbox. If there are no messages, then the procedure returns to step 250. If there are messages, then the user can browse the E-mail through the UOI 50 (step 256). Step 258 determines whether the receiving/sending management module 140 should continue running. If the user wants to use it, the procedure goes back to step 250; otherwise, step D follows. Then, with reference to FIG. 2-a, the corresponding module completes the required operations (step 230) and the process finishes.

If the user wants to send mail, a mail sending unit 142 sends out the message (step 260). After sending out the message, step 258 determines whether the receiving/sending management module 140 should continue running. If the user wants to use it, the procedure goes back to step 250; otherwise, step D follows. Then, with reference to FIG. 2-a, the corresponding module completes the required operations (step 230) and the process finishes.

The above-mentioned E-mail sending and receiving processes are completed by linking with the server 20 through the communications unit 143. The server is an ISP (Internet Service Provider).

With reference to FIG. 2-d, after step C a mail folder organizing module 130 saves E-mail messages (step 270). An attachment file type determining module determines the type of the attachment file in a message (step 272). The mail folder organizing module 130 first selects E-mail messages with attachment files and then classifies them according to the attachment file types. Finally, an auto filing module saves the messages (step 274). Files of the same type are stored in an internal storage medium of a computer executable hardware platform, followed by step D. Then, with reference to FIG. 2-a, the corresponding module completes the required operations (step 230) and the process finishes.

From FIGS. 2-a˜2-d, one can see that the disclosed Emulated real E-mail system and method can be performed with a single action. The user 10 directly selects according to the prompt menu provided by the UOI 50 to accomplish specific functions as described in FIGS. 2-a˜2-d.

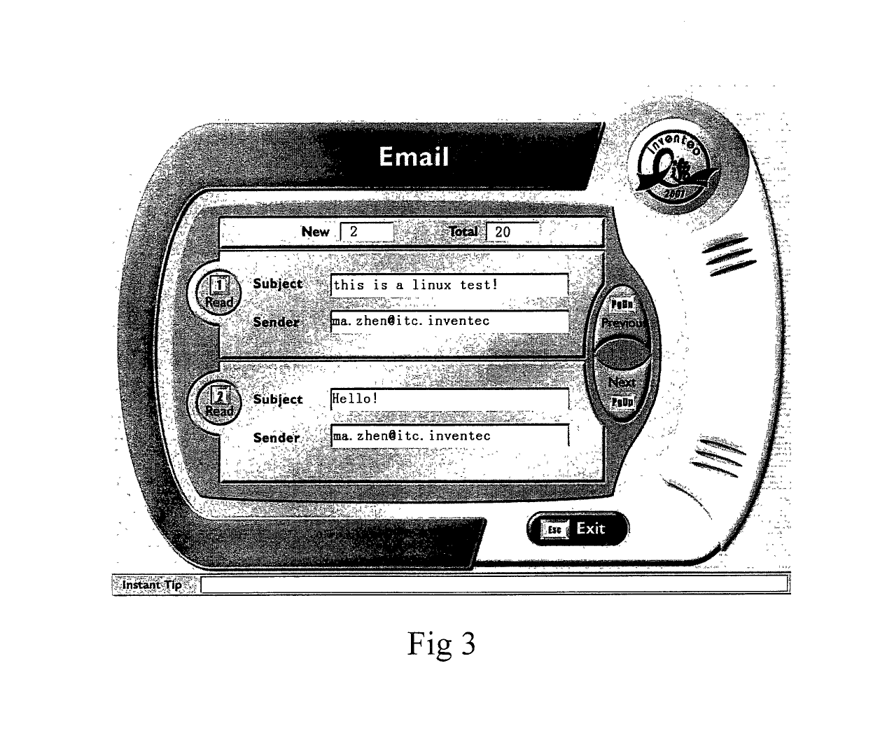

As shown in FIG. 3, the user enters an interface window and follows the hints provided in the interface window to select an E-mail message that s/he wants to view. According to a preferred embodiment of the invention, the user can view the first E-mail message by simply pressing the “1” key. Alternatively, s/he can return to the previous menu by pressing “PgUp”. In other words, the user does not need to perform extra system setting and file saving actions. To accomplish specific jobs, the user only needs to press one key. Therefore, the user can use the services provided by the computer in a more intuitive way, making unfamiliar users more willing to use computers.

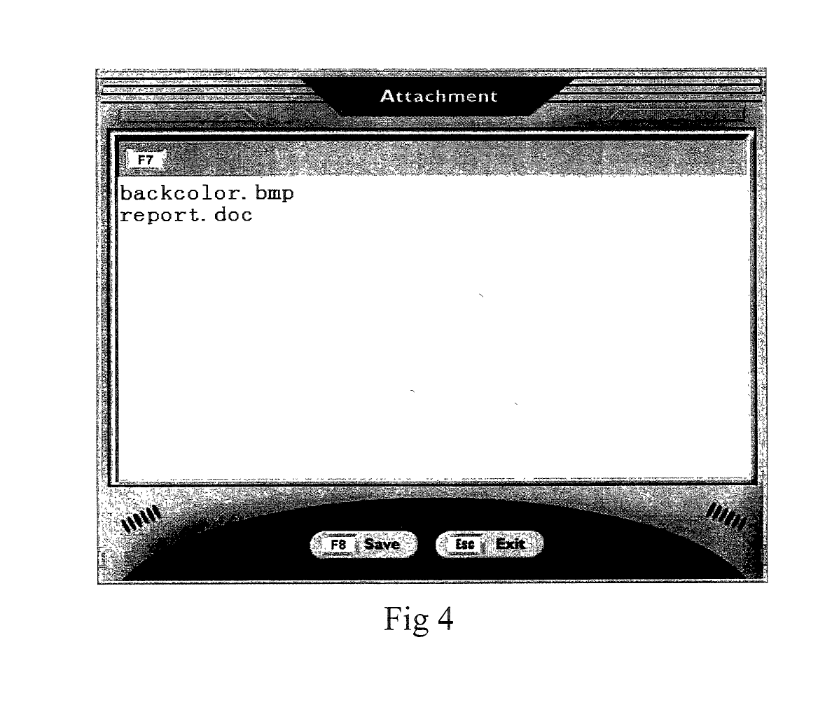

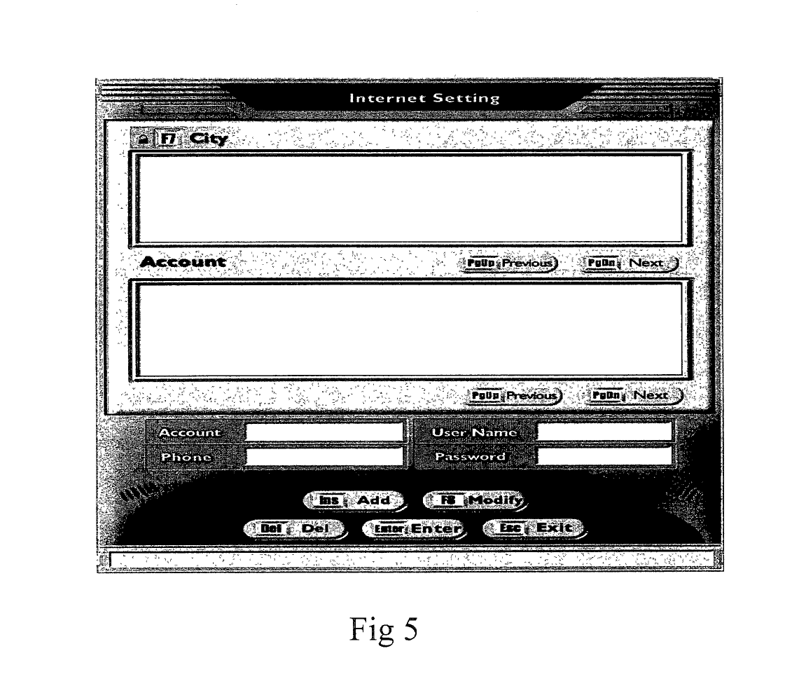

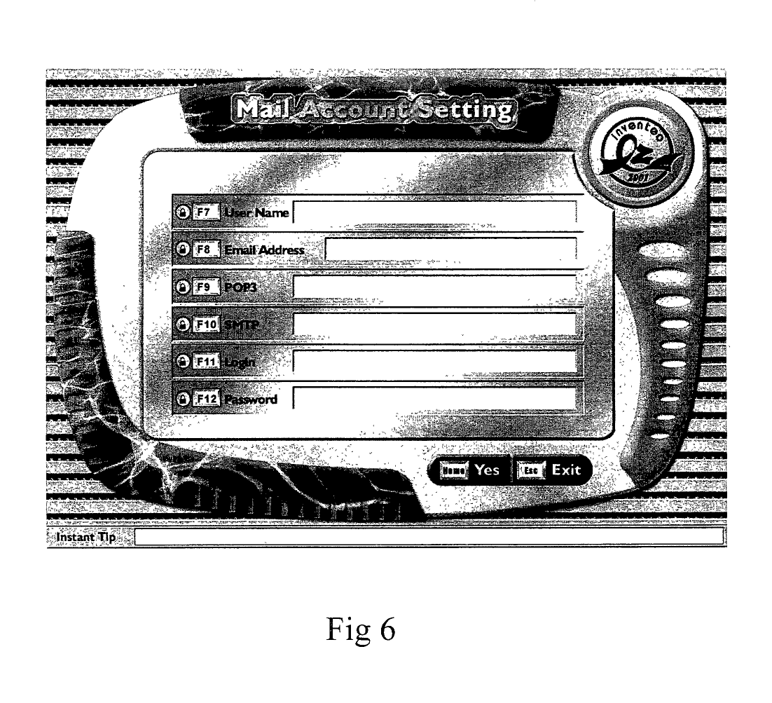

FIGS. 4, 5 and 6 are schematic views of displaying attachments, Internet settings, and E-mail account settings in the disclosed system and method. As described above, the user can accomplish a desired task with a single action. The UOI provides at least one hint menu for the user to follow in order to select a desired function in a single action.

In the invention, the one-touch OS 50 allows the user 10 to directly hit one key on the keyboard according to a selection menu to enter his or her request. Any key on the keyboard can be set to complete this kind of action. The keys include the number keys 0˜9, the letter keys A˜Z, the function keys F1˜F12 and special keys ESC, TAB, PgUp, END, etc. Aside from the keyboard, the single action request input can be accomplished using a mouse or other controller, such as the digital touch-control panel or the voice recognition system. That is, any basic input device for the computer can be used to provide one-touch control.

Although the invention has been described with reference to specific embodiments, this description is not meant to be construed in a limiting sense. Various modifications of the disclosed embodiments, as well as alternative embodiments, will be apparent to persons skilled in the art. It is, therefore, intended that the appended claims cover all modifications that fall within the true scope of the invention.

What is claimed is:

1. An Emlated real E-mail (Electronic mail) system used in a one-touch OS (Operating System) running on a computer executable hardware platform and monitored by a functional module management mechanism to manage E-mail messages through a UOI (User Operating Interface) connecting a user and a server, the functional module management mechanism comprising:
an E-mail account setting module, which provides at least a field to store parameters of one account of the user and thus establish a complete account;
a receiving/sending management module, which controls the sending/receiving procedure to send/receive E-mail messages through the complete account and further comprises:
a sending unit, which sends out an E-mail message stored in an internal storage medium of the computer executable hardware platform according to the complete account;
a receiving unit, which retrieves E-mail messages that are stored in the server and belong to the complete account;
a communications unit, which establishes communications between the receiving/sending management module and the server to transmit E-mail messages; and
a mail folder organizing module, which classifies E-mail messages according to the types of attachments in the E-mail messages and automatically file the E-mail messages.

2. The system of claim 1, wherein the one-touch OS is an OS that enables a user to complete a function provided in the work group displayed in an interface generating module in one action.

3. The system of claim 2, wherein the work group is comprised of at least one function item.

4. The system of claim 2, wherein the single action refers to the action that the user follows a selection menu generated by the UOI to perform controls using a basic I/O (Input/Output) device provided by the computer executable hardware platform.

5. The system of claim 4, wherein the basic I/O device is selected from the group consisting of a keyboard, a mouse, a digital touch-control panel and a voice recognition system.

6. The system of claim 2, wherein the UOI generates at least one set of the work group.

7. The system of claim 1, wherein the one-touch OS is able to operate with other different OS's and the user determines to switch among the different OS's.

8. The system of claim 1, wherein the one-touch OS operates alone.

9. The system of claim 1, wherein the computer executable hardware platform is selected from the group consisting of a PC (Personal Computer), an NB (Notebook), and a PDA (Personal Digital Assistant).

10. An Emlated real E-mail (Electronic mail) method used in a one-touch OS (Operating System) running on a computer executable hardware platform and monitored by a functional module management mechanism to manage E-mail messages through a UOI (User Operating Interface) connecting a user and a server, the functional module management mechanism comprising the steps of:
receiving a request signal from the user;
analyzing the request signal using the functional module management mechanism;
calling a corresponding functional module according to the request signal; and
completing a desired process by the corresponding module.

11. The method of claim 10, wherein the step of calling a corresponding functional module according to the request signal includes an E-mail account setting module, a receiving/sending management module, and a mail folder organizing module.

12. The method of claim 11, wherein that the account setting module processes the request signal includes the steps of:
generating a filed using an account setting module;
generating a hint through a UOI; and
determining whether the account setting is successful.

13. The method of claim 12, wherein the field includes at least: a user name, an E-mail address, a POP3 (Post Office Protocol) server, an SMTP (Simple Mail Transfer Protocol) server, a login name, and a password.

14. The method of claim 11, wherein the account setting module first establishes an account when the user first uses the functional module management mechanism.

15. The method of claim 11, wherein the receiving/sending management module has a mail receiving unit and a mail sending unit.

16. The method of claim 15, wherein that the mail receiving unit processes the request signal includes the steps of:
receiving E-mail messages through the mail receiving unit;
determining whether any message exists in an inbox;
browsing messages through the UOI; and
determining whether the receiving/sending management module should keep running.

17. The method of claim 15, wherein that the mail sending unit processes the request signal includes the steps of:
sending an E-mail message through the mail sending unit;
sending the message to the server through a communications unit; and
determining whether the receiving/sending management module should keep running.

18. The method of claim 17, wherein the server is an ISP (Internet Service Provider) server.

19. The method of claim 11, wherein that the mail folder organizing module processes the request signal includes the steps of:
saving E-mail messages using the mail folder organizing module;
determining attachment file types using an attachment file type determining unit; and
filing the messages using an auto filing module.

20. The method of claim 19, wherein the files being filed are stored in an internal storage medium of a computer executable hardware platform.

21. The method of claim 11, wherein the accounting setting module, the receiving/sending management module, and the mail folder module are monitored and controlled by the one-touch OS so that each command and request can be executed through a single action.

22. The method of claim 21, wherein the single action refers to the action that the user follows a selection menu generated by the UOI to perform controls using a basic I/O (Input/Output) device provided by the computer executable hardware platform.

23. The method of claim 22, wherein the basic I/O device is selected from the group comprising a keyboard, a mouse, a digital touch-control panel and a voice recognition system.
